(19) United States
(12) Patent Application Publication
(10) Pub. No.: US 2024/0370722 A1
(43) Pub. Date: Nov. 7, 2024

(54) Computer-Implemented Method to Execute a Softmax Function Using Piecewise Approximation

(71) Applicant: Aptiv Technologies AG, Schaffhausen (CH)

(72) Inventor: Christof Petig, Wuppertal (DE)

(21) Appl. No.: 18/652,008

(22) Filed: May 1, 2024

(30) Foreign Application Priority Data
May 2, 2023 (EP) 23171172

(51) Int. Cl. G06N 3/08

(52) U.S. Cl. CPC G06N 3/08

(57) ABSTRACT

A computer-implemented method of processing a classification output of a neural network. The method includes, for each input number yᵢ, determining, using an approximation of a SoftMax function that uses integer-based operations without using an exponential operation, a binary number qᵢ that represents a probability distribution of the input number yᵢ, each input number being an offset of a respective classification output of the neural network. The method includes for each input number yᵢ, determining a normalized probability pᵢ from the binary numbers qᵢ.

### CROSS-REFERENCE TO RELATED APPLICATIONS

This application claims priority to EP 23 171 172 filed May 2, 2023, the entire disclosure of which is incorporated by reference.

### FIELD

The present disclosure relates to a computer-implemented method for computing a probability distribution of a classification output using integer-based operations. In particular, the present disclosure relates to a computer-implemented method for computing a SoftMax function on a data processing device that avoids exponential operations.

### BACKGROUND

A SoftMax function normalizes an input vector into a probability distribution proportional to the exponentials of the input numbers. After applying the SoftMax function, each component in the probability distribution has a value between zero and one and the components have a sum of one. The SoftMax function may be used as the last activation function of a neural network (e.g., a classification neural network) to normalize the output of the neural network to a probability distribution over predicted output classes. To execute the SoftMax function, a processor generally needs to calculate an exponential function, which may require a significant amount of computational time and energy.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This document describes techniques and systems for computing a probability distribution of a classification output using integer-based operations. In particular, this document describes techniques and systems for executing the SoftMax function using piecewise approximation and without using exponential operations. An example processing device includes a processor that obtains input numbers y, which may be offset from original input numbers x. For each input number yᵢ, the processor determines an element number zᵢ by multiplying the input number yᵢ by an approximation of the inverse of the natural logarithm of two. Each element number zᵢ is then separated into an integral part intᵢ and a fractional part fracᵢ. A fraction component f_{c,i} is determined using a piecewise approximation of the fractional part fracᵢ. The processor then generates a binary number qᵢ that represents the exponential value of the corresponding input number yᵢ using the fraction component f_{c,i} and the integral part intᵢ. A normalized probability pᵢ is determined from the binary numbers q. In this way, the execution of the SoftMax function is optimized for integer-based processors to provide an efficient and accurate computation.

This document also describes methods performed by the above-summarized system and other configurations set forth herein and computer-executable instructions and means for performing these methods.

This Summary introduces simplified concepts related to executing the SoftMax function using piecewise approximation described in the Detailed Description and Drawings. This Summary is not intended to identify essential features of the claimed subject matter, nor is it intended to deter-mine the scope of the claimed subject matter.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

Exemplified embodiments for executing a SoftMax function using piecewise approximation are described in this document with reference to the following figures. The same numbers may be used throughout the drawings to reference like features and components:

FIG. 1 illustrates an exemplified processing device for executing a SoftMax function using piecewise approximation;

FIG. 2 illustrates an exemplified flow chart to execute a SoftMax function using piecewise approximation;

FIGS. 3-1 and 3-2 illustrate exemplified flow charts to determine element numbers as part of executing a SoftMax function using piecewise approximation;

FIG. 4 illustrates another exemplified flow chart to execute a SoftMax function using piecewise approximation; and

FIG. 5 illustrates an exemplified method to execute a SoftMax function using piecewise approximation.

In the drawings, reference numbers may be reused to identify similar and/or identical elements.

### DETAILED DESCRIPTION

Multi-layer neural networks generally end in a penultimate layer (or a penultimate activation layer) that outputs real-valued scores or probabilities that are not conveniently scaled. The SoftMax function may be used in the final layer (or last activation layer) of multi-layer neural networks to convert the scores or probabilities to a normalized probability distribution, which may be displayed to a user or used as input to another system. In other words, the SoftMax function normalizes an input vector of real numbers (e.g., the scores or probabilities) into a probability distribution that is proportional to the exponentials of the input vector. For example, with an input vector x of K real numbers xᵢ with i=1, . . . , K and x=(x₁, . . . , x_{K})∈ [symbol] ^{K}, the SoftMax function may be defined by the following mathematical formula:

$${σ ( x )}_{i} = \frac{{e}^{{x}_{i}}}{{Σ}_{j = 1}^{K} {e}^{{x}_{j}}} ,$$

where σ(x)ᵢ represents an output probability. After applying the SoftMax function, each component is in the interval (0,1) and the components sum to 1.

As an illustrative example, consider a classification neural network for recognizing cats and dogs in images. The neural network obtains as input an image and outputs a vector x that includes examples values of 2.5 for a cat, 0.5 for a dog, and 1.5 for unknown. In a first step, a processor running the SoftMax function may first subtract the maximum input value 2.5 to turn the original input values 2.5, 0.5 and 1.5 into shifted or offset input values 0, −2, −1 that are either negative or zero. Then, the processor may calculate the exponentials of the shifted input values (e.g., exp(0), exp(−2), exp(−1)), add the exponentials, and normalize the output by dividing each exponential by the sum of the exponentials to obtain output values between 0 and 1 that sum to 1. These output values provide a distribution of probabilities. In this illustrative example, the distribution of probabilities includes 56% for a cat, 11% for a dog, and 33% for unknown.

As shown in this illustrative example, the SoftMax function generates a non-linear mapping of the input vector. In other words, the most probable outcomes are amplified and the less probable outcomes (or non-meaningful outcomes) are significantly reduced or even suppressed. In other words, if one of the input numbers is small or negative (e.g., 0.5 for a dog), the SoftMax function turns it into a small probability (e.g., 11% for a dog). Similarly, if an input number is positive and large (e.g., 2.5 for a cat), the SoftMax function turns it into a large probability (e.g., 56% for a cat). The sum of the probabilities (or percentages) of the different classes is 100%. This non-linear mapping is achieved using the exponential function.

To execute the SoftMax function, a processor generally needs to calculate an exponential function, which is very costly in computing resources and energy consumption. The processor generally uses floating-point operations, resulting in many computing cycles, a long run time, and high energy usage. Furthermore, in a microcontroller or a digital signal processor with more limited capacities than other processors, floating-point numbers may be avoided because they involve a higher energy consumption and a higher demand on processing resources.

This document describes techniques and systems for executing the SoftMax function using piecewise approximation and integer-based operations. As one example, a processor obtains input numbers y, which may be offset from original input numbers x. For each input number yᵢ, the processor determines an element number zᵢ by multiplying the input number yᵢ by an approximation of the inverse of the natural logarithm of two. Each element number zᵢ is then separated into an integral part intᵢ and a fractional part fracᵢ. A fraction component f_{c,i} is determined using a linear approximation, a quadratic approximation, or any other piecewise approximation of the fractional part fracᵢ. The processor then generates a binary number qᵢ that represents the exponential value of the corresponding input number yᵢ by right-shifting the fraction component f_{c,i} by the integral part intᵢ. A normalized probability pᵢ is determined by dividing a corresponding binary number qᵢ by the sum of the binary numbers q. In this way, the execution of the SoftMax function is optimized for digital signal processors and similar controllers to provide an efficient and accurate computation. In particular, the processor executes the SoftMax function in a manner that requires fewer computing efforts and less run time. Non-limiting uses of this more efficient and accurate SoftMax computation is for image processing for the interior and/or exterior of host vehicles. For example, the image processing could be used to classify objects (e.g., road barriers, pedestrians, automobiles, bicycles, motorcycles, buildings) in the surrounding environment of a host vehicle in order to improve assisted-driving (e.g., driver alert systems) and autonomous-driving operations (e.g., object tracking). Similarly, the image processing could be used to classify objects (e.g., passengers, young children, baby carrier, box, work bag) in the interior of a host vehicle in order to improve interior monitoring systems (e.g., safety belt detection systems).

This example is just one example of the described techniques and systems for executing the SoftMax function using piecewise approximation. This document describes other examples and implementations.

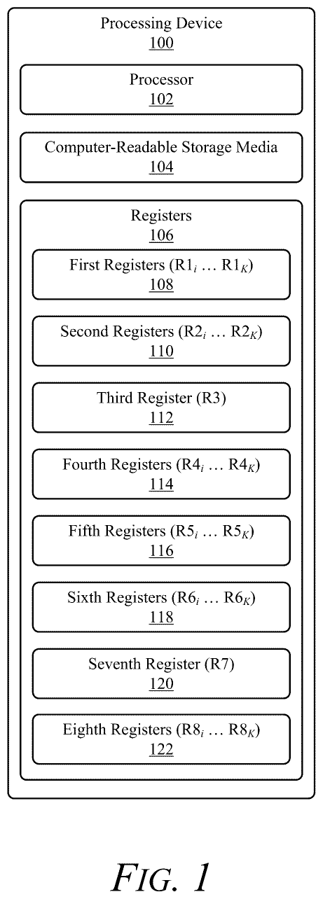

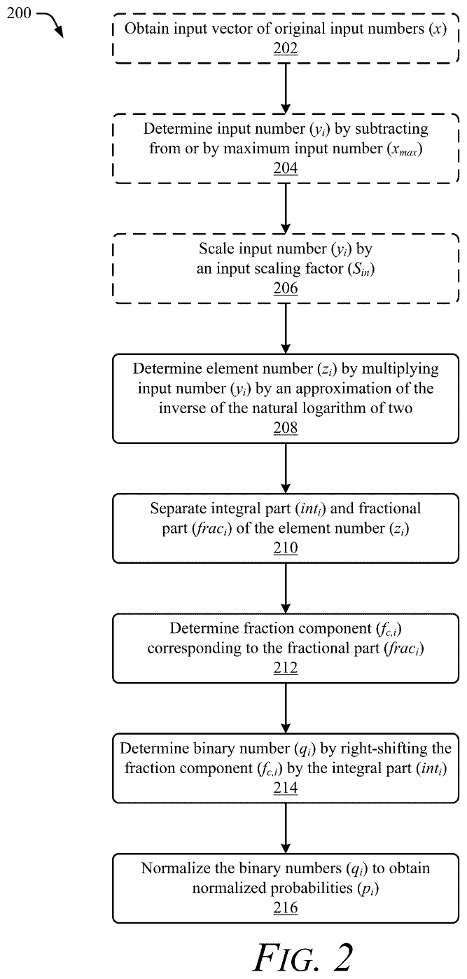

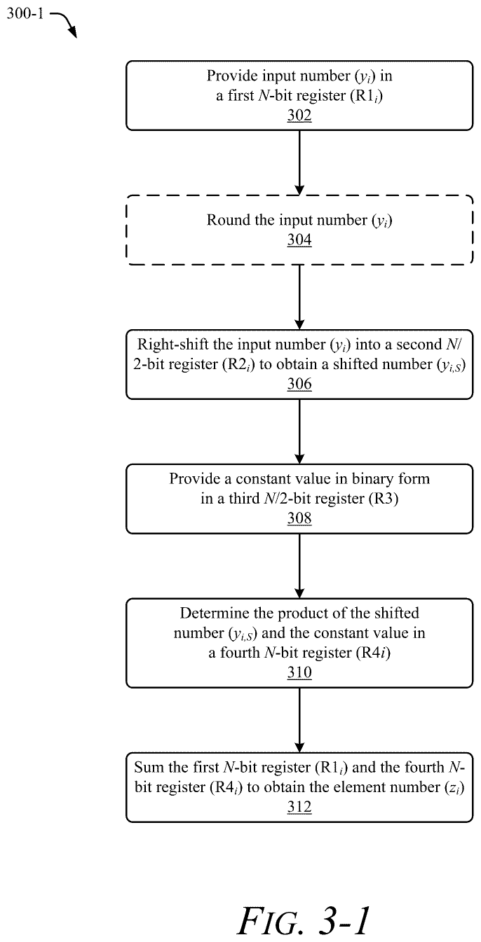

FIG. 1 illustrates an exemplified processing device 100 for executing the SoftMax function using piecewise approximation. The processing device 100 may be an integer-based digital signal processor, controller, microprocessor, or system-on-chip. The processing device 100 may include a processor 102, a computer-readable storage media (CRM) 104, and multiple registers 106. The processor 102 executes instructions stored in the CRM 104, on one or more disks, memories, or other non-transitory computer-readable storage media. For example, the processor 102 may exe-cute the instructions in the CRM 104 to carry out the methods described in FIGS. 2 through 5.

The registers 106 may include first registers 108 (e.g., R1ᵢ . . . R1_{K}), second registers 110 (e.g., R2ᵢ . . . R2_{K}), a third register 112 (e.g., R3), fourth registers 114 (e.g., R4ᵢ . . . R4_{K}), fifth registers 116 (e.g., R5ᵢ . . . R5_{K}), sixth registers 118 (e.g., R6ᵢ . . . R6_{K}), a seventh register 120 (e.g., R7), and eighth registers 122 (e.g., R8ᵢ . . . R8_{K}). In some instances, some registers may be repurposed as other registers (e.g., the first registers 108 may be repurposed or reused as the fourth registers 114). In one implementation, the registers 106 include N-bit registers and N/2-bit registers, where the number N is of the form 2ⁿ with n being an integer greater than or equal to 1 (e.g., n≥1). For example, N may be equal to 32. In other examples, N may be equal to 16 or 64 or some other value. As described in relation to FIGS. 2 through 5, the registers 106 provide data holding elements that the processor 102 may directly access while carrying out the methods described in FIGS. 2 through 5.

The processing device 100 turns the exponentiation of the SoftMax function into an exponentiation of two using the following mathematical relationship in Equation (1):

$${e}^{{y}_{i}} = {( {2}^{{log}_{2} e} )}^{{y}_{i}} = {2}^{l o {g}_{2} e * {y}_{i}} = {2}^{{z}_{i}} \qquad ( 1 )$$

$$where {z}_{i} = {log}_{2} e * {y}_{i} = \frac{1}{ln ( 2 )} * {y}_{i} and \frac{1}{ln ( 2 )} ≅ 1.442695041 .$$

The processing device 100 is more efficient and performs fewer computing cycles at calculating two to the power of a given exponent than calculating the exponential function. To further increase the efficiency of performing the SoftMax function, the processing device 100 also uses piecewise approximation to replace the floating-point calculation of the exponential function by some shifts in registers, integer additions, integer multiplications, and limiting of floating-point operations. In this way, the processing device 100 can provide more efficient image processing to classify objects inside or exterior to a host vehicle.

FIG. 2 illustrates an exemplified flow chart 200 to execute a SoftMax function using piecewise approximation. Flow chart 200 is shown as exemplified operations (or acts) performed, but not necessarily limited to the order or combinations in which the operations are shown herein. Further, any one of one or more of the operations may be repeated, combined, or reorganized to provide other flow charts. In portions of the following discussion, reference may be made to the entities detailed in FIG. 1, reference to which is made for example only. The techniques are not limited to performance by one entity or multiple entities.

In performing the operations of the flow chart 200, the processor 102 executes mainly integer (fixed-point) operations and some shifts in registers, which allows for a determination of the probability pᵢ corresponding to the input numbers yᵢ in a fast manner. The input numbers y generally represent the offset (and potentially scaled) values of the classification output (e.g., original input numbers x) from a neural network. The run time and energy consumption of the processor 102 are significantly reduced compared to performing an exponential calculation for each input number. Furthermore, a microcontroller or digital signal processor without capacity for floating-point calculations or one that has an integer-based architecture may easily use the SoftMax function using the method 200.

In an optional step 202, the processor 102 receives an input vector of K original input numbers x. The original input numbers x are real values. For example, the original input numbers x may be the real-valued scores at the output of a multi-layer neural network, such as a classification neural network, or a penultimate activation layer thereof.

In an example implementation, typically in a case that the input vector is an output from a neural network, the original input numbers x received in the step 202 are already scaled by an input scaling factor Sᵢₙ. The input scaling factor is generally equal to a power or an exponent of 2 (e.g., Sᵢₙ=2°) and rounded to an integer (e.g., the nearest integer) so as to be stored in N-bit registers. For example, the scaling happens in the input to the neural network which delivers data into a SoftMax operator. In such a case, the scaling happens outside the SoftMax operator. The input scaling factor Sᵢₙ may be chosen depending on the expected smallest and largest values of the original input numbers and the size of the N-bit registers. After scaling by Sᵢₙ, all the scaled original input numbers x can advantageously fit −2^{N-1} and 2N⁻¹−1 (in the signed integer representation).

In an optional step 204, the processor 102 determines an input number yᵢ as an offset from each original input number xᵢ (which may already scaled by Sᵢₙ) and obtains K input numbers yᵢ corresponding respectively to the K original input numbers xᵢ (e.g., positive real values, negative real values, or zero) with i=1, . . . , K. In this implementation as illustrated in Table 1 (below), the input numbers y are positive or zero. Thus, determining each input number yᵢ from the original input numbers x; includes selecting the maximum original input number xₘₐₓ and subtracting the original input numbers x from the maximum original input number xₘₐₓ so as to obtain the input numbers y that are positive or equal to zero. In other words, the input numbers y are calculated based on the expression yᵢ=xₘₐₓ−xᵢ. The K input numbers y may be stored in the first N-bit registers R1ᵢ (e.g., the first registers 108) by overwriting the original input numbers x. Alternatively, the K input numbers y may be stored in other N-bit registers (e.g., the second registers 110).

By determining the input numbers y to be positive values or zero, the processor 102 implements a positive integer approach. In an alternative implementation, the processor 102 may use a negative integer approach. In this alternative implementation, each input number yᵢ is negative or zero and derived from the original input number xᵢ by subtracting the maximum original input number xₘₐₓ from each original input number xᵢ so as to obtain the input number yᵢ. This alternative implementation may be ideal because the negative branch of the exponential function is numerically more stable than the positive branch. If this alternative implementation with negative values or zero, the constants A, B, C, D, and E of the piecewise approximation in step 212 will have different values but may be determined in a similar manner as described below.

In another implementation, the processor 102 may execute the SoftMax function using piecewise approximation without offsetting the original input numbers x to obtain the input numbers y. Instead, the processor 102 may perform steps 206 through 216 (or some subset thereof) using the original input numbers x as the input to steps 206 and 208 and obtain a normalized probability distribution thereof.

In an optional step 206, the offsets of the original input numbers x are scaled by the processor 102 by the input scaling factor Sᵢₙ. For example, the original input numbers x in Table 1 below are scaled by 227 and rounded to the nearest integer to be stored in 32-bit registers (e.g., the registers 106), which is illustrated in Table 2 below. The corresponding decimal values are indicated in Table 2 below.

TABLE 1

| xᵢ | yᵢ | zᵢ | intᵢ | fracᵢ | f_{c, i} | qᵢ | q_{i, n} | pᵢ (%) |
|---|---|---|---|---|---|---|---|---|
| 2.5 | 9.5 | 13.706 | 13 | 0.706 | 40067 | 5 | 5 | 0.0076 |
| 7 | 5 | 7.213 | 7 | 0.213 | 56670 | 443 | 440 | 0.6714 |
| −10 | 22 | 31.739 | 31 | 0.739 | 39151 | 0 | 0 | 0 |
| 12 | 0 | 0.000 | 0 | 0.000 | 65535 | 65535 | 65079 | 99.3027 |
| 0.01 | 11.99 | 17.298 | 17 | 0.298 | 53418 | 0 | 0 | 0 |
| 1 | 11 | 15.870 | 15 | 0.870 | 35755 | 1 | 1 | 0.0015 |
| 0.000001 | 12 | 17.312 | 17 | 0.312 | 52898 | 0 | 0 | 0 |
| 2 | 10 | 14.427 | 14 | 0.427 | 48792 | 3 | 3 | 0.0046 |
| 3 | 9 | 12.984 | 12 | 0.984 | 33115 | 8 | 8 | 0.0122 |
| −16 | 28 | 40.395 | 40 | 0.395 | 49904 | 0 | 0 | 0 |

TABLE 2

| xᵢ | Scaled xᵢ |
|---|---|
| 2.5 | 335,544,320 |
| 7 | 939,524,096 |
| −10 | −1,342,177,280 |
| 12 | 1,610,612,736 |
| 0.01 | 1,342,177 |
| 1 | 134,217,728 |
| 0.000001 | 134 |
| 2 | 268,435,456 |
| 3 | 402,653,184 |
| −16 | −2,147,483,648 |

Table 1 is an exemplified table illustrating example original input numbers x in the first column and offset positive input numbers y (e.g., yᵢ=xₘₐₓ−xᵢ) in the second column, as discussed below with respect to step 206. The numbers are represented by decimal values without the scaling by Sᵢₙ, for the sake of clarity. As described in greater detail above, the input numbers y can also be negative (e.g., yᵢ=xᵢ−xₘₐₓ). The third column contains the numerical values of the element number zᵢ in the decimal domain, the fourth column contains the corresponding integral parts intᵢ in the decimal domain, and the fifth column contains the corresponding fractional part fracᵢ in the decimal domain. The sixth column of Table 1 contains the scaled values of the fraction component f_{c,i} corresponding to the quadratic approximation of two raised to the negation of the fractional part fracᵢ indicated in the fifth column. The seventh column of Table 1 contains the scaled value of the binary number qᵢ in each result register R6ᵢ (e.g., the sixth registers 118) (after the right shifting of the fraction component f_{c,i} by the integral part intᵢ). As shown in the seventh column of Table 1, the result registers R6ᵢ that correspond to the non-meaningful original input numbers xᵢ (e.g., x₃, x₅, x₇, x₁₀) are set to zero.

In a step 208, which may be preceded by obtaining an input vector of input numbers y, the processor 102 determines element numbers z. Each input number yᵢ is divided by an approximation of the natural logarithm of two (e.g., ln(2)) or multiplied by an approximation of the inverse of the natural logarithm of two (e.g., 1/ln(2), ≅1.442695041) to obtain the corresponding element number zᵢ (corresponding to zᵢ=yᵢ/ln(2)). In one implementation, the multiplication of each input number yᵢ stored in a N-bit register (e.g., the first register 108, R1ᵢ,) by the constant value approximating the inverse of the natural logarithm of two (e.g., 1/ln(2)) is optimized by using a cheaper N/2-bit by N/2-bit multiplication resulting in a N-bit result. As an illustrative example, N may be equal to 32 bits. The step 208 ends by providing the element numbers z in the binary domain scaled by Sᵢₙ. The element numbers z may be stored in N-bit registers (e.g., the fifth registers 116 R5ᵢ).

In a step 210, the processor 102 separates the integral part intᵢ and the fractional part fracᵢ of each element number zᵢ. The integral part intᵢ is an integer. It can be derived from the fifth register 116 R5ᵢ by right shifting by σ bits, which results in discarding all fractional bits due to the right shift. The fractional part fracᵢ is a value that is less than 1 and greater than zero or equal to zero. It is also derived from the fifth register 116 R5ᵢ for example by masking off the bits corresponding to the integral part intᵢ.

In a step 212, the processor 102 determines a fraction component f_{c,i} corresponding to the fractional part fracᵢ. The fraction component f_{c,i} is determined using either a linear approximation or a quadratic approximation that utilizes scaling of (2^{N/2}−1). For example, if N equals 32, then the fractional part fracᵢ is determined using scaling of 2¹⁶-1 or 65,535. In particular, piecewise approximation is used to approximate the value of 2^{-frac}^{ᵢ} using the fractional part fracᵢ. The linear approximation utilizes the following equation: f_{c,i}=A+Bx. With the endpoints (e.g., 0.0 and 1.0) chosen to match the actual value and with scaling of 65,535, the constants A and B may have values of 65,535 and −32,767, respectively. The quadratic approximation utilizes the following equation: f_{c,i}=C+Dx+Ex². With the endpoints and midpoints (e.g., 0.0, 0.5, and 1.0) chosen to match the actual value and with scaling of 65,535, the constants C, D, and E may have values of 65,535, −44011.52838, and 11244.2838, respectively. The constants A, B, C, D, and E may be determined with different points matching the actual values or with different scaling. In addition, a higher-order piecewise approximation (e.g., third order) or a Taylor approximation may be used to approximate the fraction component f_{c,i}.

In a step 214, for each input number yᵢ, the processor 102 determines in a sixth N/2-bit register R6ᵢ (e.g., the sixth register 118, also termed a result register) a binary number qᵢ, which is representative of the exponential value of the input number yᵢ, by right-shifting the respective fraction component f_{c,i} by the respective integral part intᵢ.

The right shifting by the integral part intᵢ results in discarding the r less significant bits of the fraction component fcᵢ, where r is a number equal to intᵢ. For large values of the integral part intᵢ, all bits of the result register R6ᵢ become equal to zero. The binary number qᵢ resulting from the right shifting in each result register R6ᵢ may be expressed by the following formula:

$${q}_{i} = {2}^{- {int}_{i}} * f {c}_{i} = {2}^{- {int}_{i}} * ( {2}^{B} - 1 ) * {2}^{( \frac{- j}{M} )} = ( {2}^{B} - 1 ) * {2}^{- ( {int}_{i} + \frac{j}{M} )} = ( {2}^{B} - 1 ) * {2}^{- ( {int}_{i} + f r a {c}_{i} )} = ( {2}^{B} - 1 ) * {2}^{- {z}_{i}} == ( {2}^{B} - 1 ) * {e}^{- {y}_{i}} = ( {2}^{B} - 1 ) * {e}^{{x}_{i} - {x}_{max}}$$

As shown by the above relationship, the binary number qᵢ is representative of the exponential value of the original input number xᵢ. In particular, it is proportional to the exponential of xᵢ.

Then, in a step 216, the processor 102 normalizes the binary numbers q stored in the result registers R6ᵢ in order to determine the K normalized probabilities pᵢ by dividing each binary number qᵢ by the sum of the binary numbers q. In particular, the processor 102 adds all the result registers R6ᵢ with i varying from 1 to K to obtain a sum number Σ of the binary numbers q in a sum register R7 (e.g., the seventh register 120) that is a N-bit register. In the illustrative example of Table 1, the decimal value of the sum Σ is 65995.

In one exemplified implementation, normalization of the binary numbers q may involve several different steps or sub-steps. The processor 102 may obtain a normalization factor fₙ calculated using the following expression:

$${f}_{n} = \frac{( {V}_{100} ≪ {s}_{n} )}{Σ} ,$$

where V₁₀₀ represents the value obtained by setting to one (1) all bits in a N/2-bit result register R6ᵢ (e.g., the sixth register 118) and corresponds to the binary number qᵢ giving a probability value of 100% and «Sₙ represents a left shift by a normalization scaling factor Sₙ, used for the normalization (e.g., N/2, which corresponds to a scale by 2^{N/2} in the decimal domain). In some implementations, for precision improvement, the factor fₙ is rounded using the modified expression

$${f}_{n} = \frac{( {V}_{100} ≪ {S}_{n} + \frac{Σ}{2} )}{Σ} .$$

The normalization factor fₙ may be stored in a memory (e.g., the CRM 104). With reference to the example in Table 1, the value V₁₀₀ is 65535, the sum is 65995, the scaling factor is 16, and the normalization factor fₙ is given by the following expression:

$${f}_{n} = \frac{( 65 \; 535 ≪ 16 + \frac{65995}{2} )}{65995} = 65080 .$$

The processor 102 then applies the normalization factor fₙ to each result register R6ᵢ with a rescaling by the factor 1/Sₙ to obtain a normalized binary number q_{i,n} in the result register R6ᵢ. This operation may be expressed as q_{i_n}=(qᵢ*fₙ)»Sₙ, where»Sₙ represents a right shift by Sₙ in the result register R6ᵢ. The processor 102 may also round to the nearest integer by adding 2^{S}^{ₙ}⁻¹ to qᵢ*fₙ before right shifting by Sₙ in the result register R6ᵢ. Table 1 provides the normalized binary number q_{i,n} for the illustrated example in the eighth column. Table 1 illustrates the result registers R6ᵢ before and after normalization and indicates that the sum of the normalized binary numbers q_{i,n} is 65636, which corresponds to a total probability that is very close to 100% (slightly more than 100% by 1).

The processor 102 may then derive from the normalized binary numbers q_{i_n} in the result registers R6ᵢ the respective probability pᵢ (that are decimal numbers) corresponding to the input number zᵢ by dividing the normalized values q_{i_n} in the result registers R6ᵢ by the output scaling factor Sₒᵤₜ (e.g., 216 in the example of Table 1). The ninth column of Table 1 contains the probability pᵢ expressed in percentage (%). The sum of the percentage is very slightly more than 100%.

For stability improvement, operations of the flow chart 200 with a potential to overflow a register (e.g., additions, subtractions, clipping from N/2+1 to N/2 bits) may be performed as saturating operations. In other words, if the result of an operation in a register is greater than the maximum value that can be stored in the register, the register is set to the maximum (e.g., all the register bits are set to one).

For precision improvement, divisions (including any division implemented by performing a right shift in a register) in the flow chart 200 are rounded by adding half the divisor to the dividend. In other words, any division of the type “a divided by b” is advantageously executed by adding ‘b/2’ to the dividend ‘a’ before dividing by the divisor ‘b’ (or performing a corresponding right shift in a register).

FIGS. 3-1 and 3-2 illustrate exemplified flow charts 300-1 and 300-2, respectively, to determine element numbers z as part of executing a SoftMax function using piecewise approximation. Flow charts 300-1 and 300-2 are shown as exemplified operations (or acts) performed, but not necessarily limited to the order or combinations in which the operations are shown herein. In particular, flow charts 300-1 and 300-2 provide exemplified operations to carry out step 208 (e.g., determine element numbers y by multiplying by an approximation of the inverse of the natural logarithm of two) of flow chart 200. Further, any one of one or more of the operations may be repeated, combined, or reorganized to provide other flow charts. In portions of the following discussion, reference may be made to the entities detailed in FIG. 1, reference to which is made for example only. The techniques are not limited to performance by one entity or multiple entities.

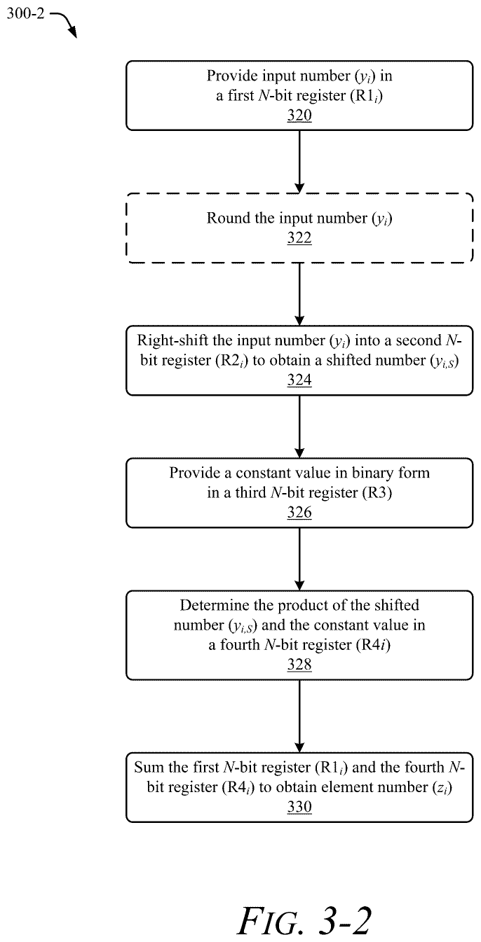

The operations of flow chart 300-1 of FIG. 3-1 begins with a step 302, in which the processor 102 provides each input number yᵢ in a first N-bit register R1ᵢ. As an example, for the processing device 100 of FIG. 1, each input number yᵢ is stored in the first 32-bit register 108 (R1ᵢ).

In an optional step 304, the processor 102 rounds each input number yᵢ. In particular, the processor 102 adds 2^{N/2-2} to the input number yᵢ.

In a step 306, the processor 102 performs a right shifting of each input number yᵢ into a second N/2-bit register R2ᵢ. The right shifting is equal to N/2−1. For the processing device 100 of FIG. 1, each input number yᵢ is right shifted by 15 bits in a second 16-bit register 108 (R2i). In other words, the N/2-1 (e.g., 15 in the illustrated example) less-significant bits are discarded by right shifting. The N/2+1 (e.g., 17 in the given example) most-significant bits are processed using one of the following rules. If the input number yᵢ after right shifting by N/2−1 does not overflow the second N/2-bit register R2ᵢ, the shifted input number y_{i,T}, is fitted or stored into the second N/2-bit register R2ᵢ. For example, when N is equal to 32, if the most-significant bit (e.g., the 32^{nd} bit) of the shifted input number is zero, the 16 least significant of the 17 bits of the input number yᵢ are right shifted by 15 and transferred into the second N/2 bit register R2ᵢ. Otherwise, if the input number yᵢ after right shifting by N/2−1 overflows the second N/2-bit register R2ᵢ, the second N/2-bit register R2ᵢ is saturated. For example, if the most significant (the N^{th} bit) bit of shifted input number y_{i,T}, is 1, each of the other N/2 (e.g., 16) most-significant bits (e.g., from the (N−1)^{th} to the N/2^{th} bit) are set to 1 and transferred into the second N/2-bit register R2ᵢ that is consequently saturated.

The shifted input number, which is referred to as y_{i,T}, is stored in the second N/2-bit register R2ᵢ. In the domain of decimal numbers, this right-shifting of the input number yᵢ by N/2-1 bits corresponds to a division by 2^{N/2-1}.

In a step 308, the processor 102 provides or loads a constant value approximating the inverse of the natural logarithm of two minus one

$$( \frac{1}{ln ( 2 )} - 1 )$$

scaled by 2^{N/2-1} in binary form in a third N/2-bit register R3. The constant value has an approximate value of 0.442695041. The constant value may be precalculated (and optionally after scaling by 2^{N/2-1}) and stored in memory in the processing device 100 or calculated in real time.

In a step 310, the processor 102 determines or calculates the product of the second N/2-bit register R2ᵢ (e.g., the shifted input number y_{i,T}) and the third N/2-bit register R3 (e.g., the constant value scaled by 2^{N/2-1}) and stores the product into a fourth N-bit register R4ᵢ. The product corresponds to

$$( \frac{1}{ln ( 2 )} - 1 ) * {y}_{i , T} ≅ 0.442695041 * {y}_{i , T} ,$$

scaled by the input scaling factor Sᵢₙ=2^{σ}.

In a step 312, the processor 102 sums the first N-bit register R1ᵢ and the fourth N-bit register R4ᵢ to obtain the element number zᵢ, which is scaled by the input scaling factor Sᵢₙ, and stores it into a fifth N-bit register R5ᵢ. Optionally, the step 312 is a saturating addition in which if the result of the addition overflows the N-bit register R5ᵢ (e.g., it is greater than the maximum value in the N-bit register R5ᵢ) all the bits are set to 1 in the N-bit register R5ᵢ (e.g., the N-bit register R5ᵢ is set to the maximum value). The saturation allows some unreasonable results (e.g., low probabilities becoming very large by numerical overflow due to the two's complement representation) to be avoided. Alternatively, the result of step 312 may be overwritten in one of the two N-bit registers R1ᵢ and R4ᵢ.

In an alternative implementation of flowchart 300-1, the steps 306 and 308 are slightly varied. In right-shifting of step 306, the processor 102 performs a right shifting of the input number yᵢ by N/2 in a second N/2-bit register R2ᵢ (e.g., in the illustrated example, this results in a right shifting by 16 bits in a 16-bit register R2ᵢ). In the step 308, the processor 102 provides or loads the constant value that approximates

$$( \frac{1}{ln ( 2 )} - 1 )$$

scaled by 2^{N/2} in binary form in a third N/2-bit register R3. This alternative implementation of flow chart 300-1 is less precise but less computationally expensive.

The operations of flowchart 300-2 of FIG. 3-2 begins with a step 320, which is identical to step 302 of FIG. 3-1. In the step 320, the processor 102 provides each input number yᵢ in a first N-bit register R1ᵢ. As an example, for the processing device 100 of FIG. 1, each input number yᵢ is stored in the first 32-bit register 108 (R1ᵢ).

In an optional step 322, which is similar to the optional step 304 of FIG. 3-1, the processor 102 rounds each input number yᵢ. In particular, the processor 102 adds 2^{N/2-3} to the input number yᵢ.

In a step 324, which is similar to the step 306 of FIG. 3-1, the processor 102 performs a right shifting of each input number yᵢ into a second N-bit register R2ᵢ. The right shifting is equal to N/2−2. For the processing device 100 of FIG. 1, each input number yᵢ is right shifted by 14 bits in a second 32-bit register 108 (R2ᵢ). In other words, the N/2−2 (e.g., 14 in the illustrated example) less-significant bits are discarded by right shifting. The N/2+2 (e.g., 18 in the given example) most-significant bits are maintained in the first N-bit register R2ᵢ as the N/2+2 least-significant bits (e.g., the N/2−2 most significant bits are set to 0). The first and the second N-bit register R1ᵢ and R2ᵢ may either be the same N-bit register or two distinct N-bit registers.

In a step 326, which is similar to the step 308 of FIG. 3-1, the processor 102 provides or loads a constant value that approximates the inverse of the natural logarithm of two minus one

$$( \frac{1}{ln ( 2 )} - 1 )$$

scaled by 2^{N/2-2} in binary form in a third N-bit register R3. The constant value has an approximate value of 0.442695041. The constant value may be precalculated (and optionally after scaling by 2^{N/2-1}) and stored in memory in the processing device 100 or calculated in real time.

In a step 328, which is similar to the step 310 of FIG. 3-1, the processor 102 determines or calculates the product of the second N-bit register R2ᵢ (e.g., the shifted input number y_{i,T}) and the third N-bit register R3 (e.g., the constant value scaled by 2^{N/2-1}) and stores the product into a fourth N-bit register R4ᵢ. The product corresponds to

$$( \frac{1}{ln ( 2 )} - 1 ) * {y}_{i , T} ≅ 0.442695041 * {y}_{i , T} ,$$

scaled by the input scaling factor Sᵢₙ−2^{σ}.

This multiplication in step 328 is more costly in computing resources than the multiplication of step 318, which is a N/2-bit by N/2-bit multiplication. Alternatively, the second N-bit register R2ᵢ (which may also be the first register R1ᵢ in cases that the input number yᵢ is right shifted in the same register for step 324) can be overwritten by the result of the multiplication (instead of using another N-bit register). In other words, the fourth N-bit register R4ᵢ may be the N-bit register R2ᵢ.

In a step 330, which is similar to step 312 of FIG. 3-1, the processor 102 sums the first N-bit register R1ᵢ and the fourth N-bit register R4ᵢ to obtain the element number zᵢ, which is scaled by the input scaling factor Sᵢₙ, and stores it into a fifth N-bit register R5ᵢ. Optionally, the step 330 is a saturating addition in which if the result of the addition overflows the N-bit register R5ᵢ (e.g., it is greater than the maximum value in the N-bit register R5ᵢ) all the bits are set to 1 in the N-bit register R5ᵢ (e.g., the N-bit register R5ᵢ is set to the maximum value). The saturation allows some unreasonable results (e.g., low probabilities becoming very large by numerical overflow due to the two's complement representation) to be avoided. Alternatively, the result of step 330 may be overwritten in one of the two N-bit registers R1ᵢ and R4ᵢ.

In flow chart 300-2, there is no need for saturation. The operations of flow chart 300-2 are more precise (because there is one more bit of precision for the shifted input number) but also a little more costly in computing resources.

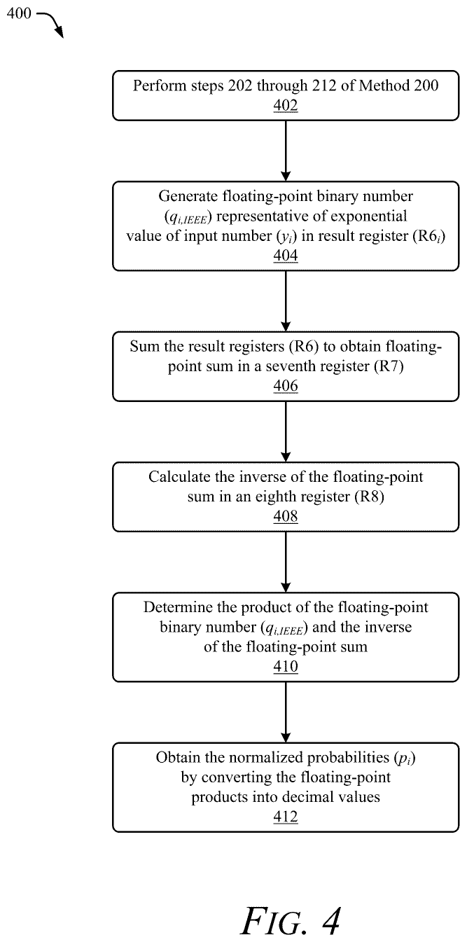

FIG. 4 illustrates another exemplified flow chart 400 to execute a SoftMax function using piecewise approximation. Flow chart 400 is shown as exemplified operations (or acts) performed, but not necessarily limited to the order or combinations in which the operations are shown herein. Further, any one of one or more of the operations may be repeated, combined, or reorganized to provide other flow charts. In portions of the following discussion, reference may be made to the entities detailed in FIGS. 1 through 3-2, reference to which is made for example only. The techniques are not limited to performance by one entity or multiple entities.

In performing the operations of flow chart 400, the processor 102 executes a positive and fixed-point approach. The flow chart 400 reduces the efforts to use floating point operations with the processor 102 calculating more in fixed points and less in floating points.

In a step 402, the processor 102 performs the steps 202 through 212 or the steps 208 through 212 described in connection with the flow chart 200 of FIG. 2.

In a step 404, the processor 102 generates a floating-point binary number q_{i,IEEE} representative of the exponential value of each input number yᵢ in a N-bit result register R6ᵢ (e.g., the sixth registers 118) by combining the fraction component f_{c,i} and the integral part intᵢ. In flow chart 400, the floating-point approach means that all the binary numbers representative of the exponential values of the input numbers y are floating-point numbers and, in particular, IEEE 754 floating-point numbers. According to the IEEE standard for Floating-Point Arithmetic (IEEE 754), a N-bit floating point has a layout defined by one sign bit (the most significant bit), a N1-bit exponent part and a N2-bit mantissa. In an example layout for a 32-bit floating point number (−248,75), the exponent is a 8-bit part and the mantissa is a 23-bit part.

The processor 102 generates the floating-point binary number qᵢ, IEEE by combining the integral part intᵢ and the IEEE 754 exponent bias (e.g., by subtracting the integral part intᵢ from the bias) and transferring the integral part intᵢ combined with the IEEE 754 exponent bias in the exponent part of the floating-point binary number qᵢ, IEEE in the N-bit result register R6ᵢ. The processor 102 then transfer the fraction component f_{c,i} into the mantissa of the floating-point binary number q_{i,IEEE} in the N-bit result register R6ᵢ, if needed, by adding bits set at 0 on the least significant bits (e.g., if the fraction component f_{c,i} is represented by 16 bits, it is transferred to the 16 most significant bits of the mantissa and the other least significant bits of the mantissa are set to 0). In this way, the exponent of the floating-point binary number q_{i,IEEE} is a combination of the integral part intᵢ stored in binary form in the result register R6ᵢ and the IEEE 754 exponent bias and the mantissa is directly derived from the fraction component f_{c,i}. In the flow chart 400, the constants A, B, C, D, and E used to approximate the fraction component f_{c,i} are adjusted to match the IEEE 754 fraction components, which means the fraction components f_{c} are identical or directly transformable from one to the other (e.g., by simply adding 0 on the right).

The processor 102 then adds the result registers R6ᵢ by performing a floating-point addition to obtain a sum Σ_{IEEE}, which is a floating-point number, in a result register R7. The processor 102 calculates the inverse of the sum Σ_{IEEE} and stores the result in a register R8 (e.g., the eighth register 122) in floating-point. The processor 102 then multiplies each result register R6ᵢ by the register R8. In other words, the product of each floating-point binary number q_{i,IEEE} and the inverse of the sum Σ_{IEEEE} is calculated and stored in a register R8ᵢ that is a N-bit register. The normalized probability pᵢ corresponding to the input number yᵢ can be obtained by converting the floating-point numbers stored in the registers R8i into decimal values.

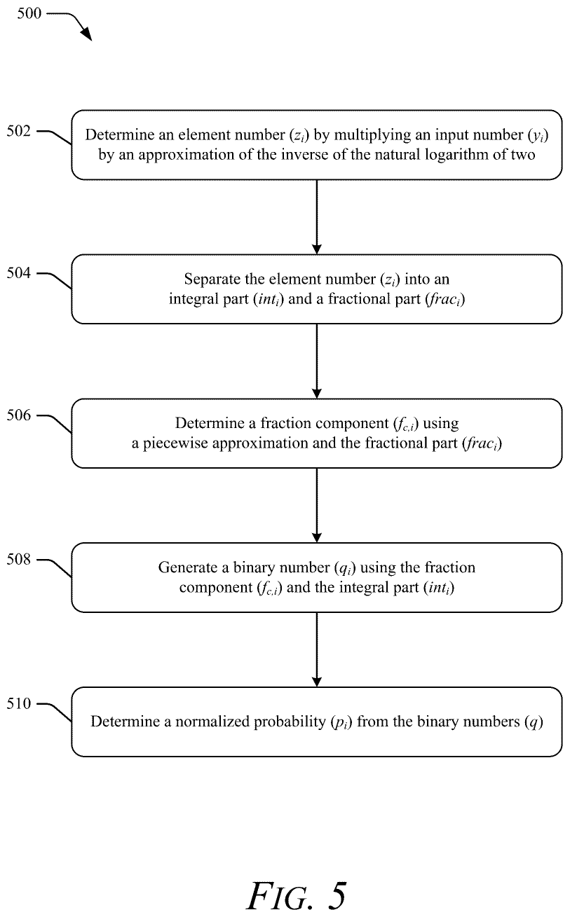

FIG. 5 illustrates an exemplified method 500 to execute a SoftMax function using piecewise approximation. In other words, method 500 illustrates operations to process classification outputs (or offset values thereof) of a neural network to generate normalized probabilities thereof. Method 500 is shown as operations (or acts) performed, but not necessarily limited to the order or combinations in which the operations are shown herein. Further, any one of one or more of the operations may be repeated, combined, or reorganized to provide other methods. In portions of the following discussion, reference may be made to the processor 102 of FIG. 1, and other entities detailed in FIGS. 1 through 4 reference to which is made for example only. The techniques are not limited to performance by one entity or multiple entities.

At step 502, for a quantity K of input numbers y, an element number zᵢ is determined by multiplying a corresponding input number yᵢ by an approximation of the inverse of the natural logarithm of two. For example, the processor 102 multiplies each input number yᵢ by a constant representing or approximating the inverse of the natural logarithm of two to determine a corresponding element number zᵢ.

In one embodiment, the processor 102 may calculate each element number zᵢ by storing each input number yᵢ in binary form into a first N-bit register, with N being a power of two and greater than or equal to two. The processor 102 may then right shift each input number yᵢ by N/2−1 and store the right-shifted input number y_{i,T} into a second N/2-bit register. If the input number yᵢ, after right shifting by N/2−1, does not overflow the second N/2-bit register, the right-shifted input number y_{i,T} may be fitted into the second N/2-bit register. If the input number yᵢ, after right shifting by N/2−1, overflows the second N/2-bit register, the second N/2-bit register may be saturated. The right-shifted input number y_{i,T} may also be rounded by adding 2^{N/2-2} to the input number yᵢ before right shifting by N/2−1. The processor 102 may then provide a constant value in binary form into a third N/2-bit register. The constant value is approximately equal to an inverse of the natural logarithm of two minus one and scaled by 2N/2−1. The processor 102 may calculate a product of the second N/2-bit register and the third N/2-bit register and store the product into a fourth N-bit register. The processor 102 may then determine a sum of the first N-bit register and the fourth N-bit register by using a saturating addition to obtain the element number zᵢ and storing the sum in a fifth N-bit register.

In another implementation, the processor 102 may calculate each element number zᵢ by storing each input number yᵢ in binary form into a first N-bit register. The processor 102 may then right shift the input number yᵢ by N/2−2 and store the right-shifted input number y_{i,T} into a second N-bit register. The right-shifted input number y_{i,T} may also be rounded by adding 2^{N/2-3} to the input number yᵢ before right shifting by N/2−2. A constant value may then be provided in binary form and scaled by 2N/2−2 into a third N-bit register. The constant value is approximately equal to an inverse of the natural logarithm of two minus one. The processor 102 may then calculate a product of the second N-bit register and the third N-bit register and store the product into a fourth N-bit register. Finally, the processor 102 may determine a sum of the first N-bit register and the fourth N-bit register by using a saturating addition to obtain the element number zᵢ scaled by an input scaling factor Sᵢₙ and store the sum in a fifth N-bit register.

Depending on the output of a penultimate activation layer in a multi-layer neural network, the processor 102 may derive each input number yᵢ from a corresponding original input number xᵢ contained in an input vector of K original input numbers x. The processor 102 may select the maximum original input number xₘₐₓ from among the original input numbers x. For each original input number xᵢ, the processor 102 may subtract the maximum original input number xₘₐₓ from the input number xᵢ so as to obtain a negative or zero input number yᵢ or it may subtract the original input number x; from the maximum original input number xₘₐₓ so as to obtain a zero or positive input number yᵢ.

In addition, each input number yᵢ may be in binary form and scaled by an input scaling factor Sᵢₙ. The input scaling factor Sᵢₙ may be determined based on the expected smallest and largest values of the input numbers y and a size N of the first registers. The processor 102 may store each input number yᵢ in a first N-bit register.

At step 504 and for each element number zᵢ, the element number zᵢ is separated into an integral part intᵢ and a fractional part fracᵢ. For example, the processor 102 can provide the integral part intᵢ and a fractional part fracᵢ into corresponding registers.

At step 506 and for each fractional part fracᵢ, a fraction component f_{c,i} is determined using a piecewise approximation (e.g., a linear approximation or a quadratic approximation) of two raised to the negation of the fractional part fracᵢ (e.g., 2^{-frac}^{ᵢ}). For example, the processor 102 may utilize a linear approximation or a quadratic approximation. In particular, the processor 102 may approximate the fraction component f_{c,i} by adding a first constant A to a first product of a second constant B and the fractional part fracᵢ to calculate a linear approximation thereof. The processor 102 may also approximate the fraction component f_{c,i} by adding a third constant C to a second product of a fourth constant D and the fractional part fracᵢ and a third product of a fifth constant E and a square of the fractional part fracᵢ (e.g, C+Dfracᵢ+Efracᵢ²) to calculate a quadratic approximation thereof. Similarly, the processor 102 may approximate the fraction component f_{c,i} by adding a third constant C′ to a product of the fractional part fracᵢ and the sum of a fourth constant D′ and a product of a fifth constant E′ and the fractional part fracᵢ (e.g, C′+fracᵢ(D′+E′*fracᵢ)) to calculate a quadratic approximation thereof.

At step 508 and corresponding to each input number yᵢ, a binary number qᵢ that represents an exponential value of the input number yᵢ is generated using the fraction component f_{c,i} and the integral part intᵢ. For example, the processor 102 may right-shift the fraction component f_{c,i} by a value of the integral part intᵢ to determine each binary number qᵢ. In particular, the processor 102 may store the corresponding fraction component f_{c,i} into the respective result register and right shift the fraction component f_{c,i} by the integral part intᵢ into the respective result register. In another implementation, the processor 102 may generate the binary number qᵢ in the result register in a form of an IEEE 754 floating-point number that includes an exponent and a mantissa. The exponent is a combination of the integral part intᵢ in binary form and the IEEE 754 exponent bias. The mantissa is derived from the fraction component f_{c,i}.

Steps 502 through 508 provide an example of determining the binary numbers q corresponding to respective input numbers y of the classification outputs of a neural network. The binary numbers q may be determined using an approximation of the SoftMax function that uses integer-based operations without using an exponential operation. The binary numbers q represent a probability distribution of each input number.

At step 510 and corresponding to each input number yᵢ, a normalized probability pᵢ is determined from the binary numbers q. For example, the processor 102 may divide each binary number qᵢ by a sum of the binary numbers q. In particular, the processor 102 may place each binary number qᵢ into a respective result register and sum the quantity K of result registers into a sum register. The processor 102 may then divide each result register by the sum register to calculate the normalized probabilities p. Alternatively, the processor may then multiply each result register by an inverse of the sum register (e.g., to perform a single division operation) to calculate the normalized probabilities p.

In another implementation, the processor 102 may sum the quantity K of result registers into a sum register and then obtain a normalization factor fₙ by scaling a value V₁₀₀ by a normalization scaling factor Sₙ. The value V₁₀₀ is obtained by setting to 1 all the bits in each result register. The processor 102 may then apply the normalization factor fₙ to each result register with an inverse scaling by the normalization scaling factor Sₙ to obtain a normalized binary number q_{i_n} and then divide each result register by the sum register (e.g., a sum of the normalized binary numbers qₙ) to calculate the normalized probabilities p.

### EXAMPLES

In the following section, examples are provided.
Example 1. A computer-implemented method of processing a classification output of a neural network, the method comprising: for each input number yᵢ, determining, using an approximation of a SoftMax function that uses integer-based operations without using an exponential operation, a binary number qᵢ that represents a probability distribution of the input number yᵢ, each input number being an offset of a respective classification output of the neural network; and for each input number yᵢ, determining a normalized probability pᵢ from the binary numbers q.
Example 2. The computer-implemented method of Example 1, wherein determining the binary number qᵢ comprises: for each input number yᵢ, determining an element number zᵢ by multiplying the input number yᵢ by an approximation of an inverse of the natural logarithm of two; for each element number zᵢ, separating the element number zᵢ into an integral part intᵢ and a fractional part fracᵢ for each fractional part fracᵢ, determining a fraction component f_{c,i} using a piecewise approximation of two raised to a power of a negation the fractional part fracᵢ; and generating the binary number qᵢ using the fraction component f_{c,i} and the integral part intᵢ, the binary number qᵢ corresponding to the input number yᵢ and further representing an exponential value of the input number yᵢ.
Example 3. The computer-implemented method of Example 2, wherein determining the fraction component f_{c,i} comprises calculating a linear approximation or a quadratic approximation of two raised to the power of the negation of the fractional part fracᵢ by: approximating the fraction component f_{c,i} by adding a first constant A to a first product of a second constant B and the fractional part fracᵢ; or approximating the fraction component f_{c,i} by adding a third constant C to a second product of a fourth constant D and the fractional part fracᵢ and a third product of a fifth constant E and a square of the fractional part fracᵢ.
Example 4. The computer-implemented method of any one of Examples 1 through 3, wherein determining the normalized probability pᵢ from the binary numbers q comprises: placing each binary number qᵢ into a respective result register; summing the quantity K of result registers into a sum register; and multiplying each result register by an inverse of the sum register or dividing each result register by the sum register.
Example 5. The computer-implemented method of Example 4, wherein generating the binary number qᵢ comprises right shifting the fraction component f_{c,i} by a value of the integral part intᵢ by: storing the corresponding fraction component f_{c,i} into the respective result register and right shifting the fraction component f_{c,i} by the value of the integral part intᵢ into the respective result register.
Example 6. The computer-implemented method of any one of the previous Examples, wherein each input number yᵢ is scaled by an input scaling factor Sᵢₙ and stored in a first N-bit register.
Example 7. The computer-implemented method of Example 6, wherein the input scaling factor Sᵢₙ is determined based on expected smallest and largest values of the input numbers y and a size N of the first registers.
Example 8. The computer-implemented method of any one of Examples 2 through 5, wherein determining the element number zᵢ by multiplying the input number yᵢ by the approximation of the inverse of the natural logarithm of two comprises: storing each input number yᵢ in binary form into a first N-bit register; right shifting the input number yᵢ by N/2−1 and storing the right-shifted input number y_{i,T} into a second N/2-bit register according to: if the input number yᵢ, after right shifting by N/2−1, does not overflow the second N/2-bit register, fitting the right-shifted input number y_{i,T} into the second N/2-bit register, or if the input number yᵢ, after right shifting by N/2−1, overflows the second N/2-bit register, saturating the second N/2-bit register; providing a constant value in binary form into a third N/2-bit register, the constant value being approximately equal to the inverse of the natural logarithm of two minus one scaled by 2N/2−1; calculating a product of the second N/2-bit register and the third N/2-bit register and storing the product into a fourth N-bit register; and determining a sum of the first N-bit register and the fourth N-bit register by implementing a saturating addition to obtain the element number zᵢ and storing the sum in a fifth N-bit register.
Example 9. The computer-implemented method of Example 8, wherein determining the element number zᵢ by multiplying the input number yᵢ by the approximation of the inverse of the natural logarithm of two further comprises: rounding the right-shifted input number y_{i,T} by adding 2^{N/2-2} to the input number yᵢ before right shifting by N/2−1.
Example 10. The computer-implemented method of any one of Examples 2 through 5, wherein determining the element number zᵢ by multiplying the input number yᵢ by the approximation of the inverse of the natural logarithm of two comprises: storing each input number yᵢ in binary form into a first N-bit register; right shifting the input number yᵢ by N/2−2 and storing the right-shifted input number y_{i,T} into a second N-bit register; providing a constant value in binary form scaled by 2N/2−2 into a third N-bit register (R3), the constant value being approximately equal to the inverse of the natural logarithm of two minus one; calculating a product of the second N-bit register and the third N-bit register and storing the product into a fourth N-bit register; and determining a sum of the first N-bit register and the fourth N-bit register by implementing a saturating addition to obtain the element number zᵢ scaled by an input scaling factor Sᵢₙ and storing the sum in a fifth N-bit register.
Example 11. The computer-implemented method of Example 10, wherein determining the element number zᵢ by multiplying the input number yᵢ by the approximation of the inverse of the natural logarithm of two further comprises: rounding the right-shifted input number y_{i,T} by adding 2^{N/2-3} to the input number yᵢ before right shifting by N/2−2.
Example 12. The computer-implemented method of Example 9 or 11, wherein determining the normalized probability pᵢ comprises: summing the result registers into a sum register; obtaining a normalization factor fₙ by scaling a value V₁₀₀, the value V₁₀₀ obtained by setting to 1 all the bits in each result register, by a normalization scaling factor Sₙ; and applying the normalization factor fₙ to each result register with an inverse scaling by the normalization scaling factor Sₙ to obtain a normalized binary number q_{i_n}.
Example 13. The computer-implemented method of Example 4, wherein the binary number qᵢ is generated in the result register in a form of an IEEE 754 floating-point number including an exponent and a mantissa, wherein the exponent is a combination of the integral part intᵢ in binary form and the IEEE 754 exponent bias and the mantissa is derived from the fraction component f_{c,i}.
Example 14. The computer-implemented method of any one of the previous Examples, wherein the computer-implemented method further comprises: deriving each input number yᵢ from a corresponding original input number x; by selecting the maximum original input number xₘₐₓ from among original input numbers x, the original input numbers x being the classification output of the neural network; and for each original input number xx: subtracting xₘₐₓ from xᵢ so as to obtain a negative or zero input number yᵢ; or subtracting xᵢ from xₘₐₓ so as to obtain a zero or positive input number yᵢ.
Example 15. A system comprising one or more processors configured to perform the computer-implemented method of any one of the previous Examples.
Example 16. A non-transitory computer-readable media that stores computer-executable instructions that, when executed by a processor of a data processing device, cause the processor to perform the computer-implemented method of any one of Examples 1 through 14.

### CONCLUSION

While various embodiments of the disclosure are described in the foregoing description and shown in the drawings, it is to be understood that this disclosure is not limited thereto but may be variously embodied to practice within the scope of the following claims. From the foregoing description, it will be apparent that various changes may be made without departing from the scope of the disclosure as defined by the following claims.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A computer-implemented method of processing a classification output of a neural network, the method comprising:
for each input number yᵢ, determining, using an approximation of a SoftMax function that uses integer-based operations without using an exponential operation, a binary number qᵢ that represents a probability distribution of the input number yᵢ, each input number being an offset of a respective classification output of the neural network; and
for each input number yᵢ, determining a normalized probability pᵢ from the binary numbers qᵢ.

2. The computer-implemented method of claim 1 wherein determining the binary number qᵢ includes:
for each input number yᵢ, determining an element number zᵢ by multiplying the input number yᵢ by an approximation of an inverse of a natural logarithm of two;
for each element number zᵢ, separating the element number zᵢ into an integral part intᵢ and a fractional part fracᵢ;
for each fractional part fracᵢ, determining a fraction component f_{c,i} using a piecewise approximation of two raised to a power of a negation of the fractional part fracᵢ; and
generating the binary number qᵢ using the fraction component f_{c,i} and the integral part intᵢ, the binary number qᵢ corresponding to the input number yᵢ and further representing an exponential value of the input number yᵢ.

3. The computer-implemented method of claim 2 wherein determining the fraction component f_{c,i} includes calculating a linear approximation or a quadratic approximation of two raised to the power of the negation of the fractional part fracᵢ by:
approximating the fraction component f_{c,i} by adding a first constant A to a first product of a second constant B and the fractional part fracᵢ; or
approximating the fraction component f_{c,i} by adding a third constant C to a second product of a fourth constant D and the fractional part fracᵢ and a third product of a fifth constant E and a square of the fractional part fracᵢ.

4. The computer-implemented method of claim 3 wherein determining the normalized probability pᵢ from the binary numbers qᵢ includes:
placing each binary number qᵢ into a respective result register;
summing a quantity K of result registers into a sum register; and
multiplying each result register by an inverse of the sum register or dividing each result register by the sum register.

5. The computer-implemented method of claim 4 wherein generating the binary number qᵢ includes right shifting the fraction component f_{c,i} by a value of the integral part intᵢ by:
storing the corresponding fraction component f_{c,i} into the respective result register and right shifting the fraction component f_{c,i} by the value of the integral part intᵢ into the respective result register.

6. The computer-implemented method of claim 1 wherein each input number yᵢ is scaled by an input scaling factor Sᵢₙ and stored in a first N-bit register.

7. The computer-implemented method of claim 6 wherein the input scaling factor Sᵢₙ is determined based on expected smallest and largest values of the input numbers yᵢ and a size N of the first registers.

8. The computer-implemented method of claim 4 wherein determining the element number zᵢ by multiplying the input number yᵢ by the approximation of the inverse of the natural logarithm of two includes:
storing each input number yᵢ in binary form into a first N-bit register;
right shifting the input number yᵢ by N/2−1 creating a right-shifted input number y_{i,T} and storing the right-shifted input number y_{i,T} into a second N/2-bit register according to:
in response to the input number yᵢ, after right shifting by N/2−1, not overflowing the second N/2-bit register, fitting the right-shifted input number y_{i,T} into the second N/2-bit register, or
in response to the input number yᵢ, after right shifting by N/2−1, overflowing the second N/2-bit register, saturating the second N/2-bit register;
providing a constant value in binary form into a third N/2-bit register, the constant value being approximately equal to the inverse of the natural logarithm of two minus one scaled by 2N/2−1;
calculating a product of the second N/2-bit register and the third N/2-bit register and storing the product into a fourth N-bit register; and
determining a sum of the first N-bit register and the fourth N-bit register by implementing a saturating addition to obtain the element number zᵢ and storing the sum in a fifth N-bit register.

9. The computer-implemented method of claim 8 wherein determining the element number zᵢ by multiplying the input number yᵢ by the approximation of the inverse of the natural logarithm of two further includes:
rounding the right-shifted input number y_{i,T} by adding 2^{N/2-2} to the input number yᵢ before right shifting by N/2−1.

10. The computer-implemented method of claim 2 wherein determining the element number zᵢ by multiplying the input number yᵢ by the approximation of the inverse of the natural logarithm of two includes:
storing each input number yᵢ in binary form into a first N-bit register;
right shifting the input number yᵢ by N/2−2 creating a right-shifted input number y_{i,T} and storing the right-shifted input number y_{i,T} into a second N-bit register;
providing a constant value in binary form scaled by 2N/2−2 into a third N-bit register, the constant value being approximately equal to the inverse of the natural logarithm of two minus one;
calculating a product of the second N-bit register and the third N-bit register and storing the product into a fourth N-bit register; and
determining a sum of the first N-bit register and the fourth N-bit register by implementing a saturating addition to obtain the element number zᵢ scaled by an input scaling factor Sᵢₙ and storing the sum in a fifth N-bit register.

11. The computer-implemented method of claim 10 wherein determining the element number zᵢ by multiplying the input number yᵢ by the approximation of the inverse of the natural logarithm of two further includes:
rounding the right-shifted input number y_{i,T} by adding 2^{N/2-3} to the input number yᵢ before right shifting by N/2−2.

12. The computer-implemented method of claim 9 wherein determining the normalized probability pᵢ includes:
summing the result registers into a sum register;
obtaining a normalization factor fₙ by scaling a value V₁₀₀, the value V₁₀₀ obtained by setting to 1 all bits in each result register, by a normalization scaling factor Sₙ; and
applying the normalization factor fₙ to each result register with an inverse scaling by the normalization scaling factor Sₙ to obtain a normalized binary number q_{i_n}.

13. The computer-implemented method of claim 4 wherein the binary number qᵢ is generated in the result register in a form of an IEEE 754 floating-point number including an exponent and a mantissa, wherein the exponent is a combination of the integral part intᵢ in binary form and IEEE 754 exponent bias and the mantissa is derived from the fraction component f_{c,i}.

14. The computer-implemented method of claim 1 further comprising:
deriving each input number yᵢ from a corresponding original input number xᵢ by selecting a maximum original input number xₘₐₓ from among original input numbers x, the original input numbers x being the classification output of the neural network; and
for each original input number xᵢ:
subtracting xₘₐₓ from xᵢ so as to obtain a negative or zero input number yᵢ; or
subtracting x; from xₘₐₓ so as to obtain a zero or positive input number yᵢ.

15. A system comprising:
memory hardware configured to store instructions; and
processing hardware configured to execute the instructions, wherein the instructions include:
for each input number yᵢ, determining, using an approximation of a SoftMax function that uses integer-based operations without using an exponential operation, a binary number qᵢ that represents a probability distribution of the input number yᵢ, each input number being an offset of a respective classification output of a neural network; and
for each input number yᵢ, determining a normalized probability pᵢ from the binary numbers qᵢ.
